(19) United States
(12) Patent Application Publication
(10) Pub. No.: US 2017/0322794 A1
(43) Pub. Date: Nov. 9, 2017

(54) System and Method for Data Validation between Synced Devices

(71) Applicant: Sharp Laboratories of America, Inc., Camas, WA (US)

(72) Inventors: Andrew Ferlitsch, Camas, WA (US); Deborah Pritchett, Vancouver, WA (US)

(21) Appl. No.: 15/149,234

(22) Filed: May 9, 2016

(51) Int. Cl. G06F 9/445; H04L 29/06

(52) U.S. Cl. CPC G06F 8/65; H04L 67/42

(57) ABSTRACT

Disclosed herein are a system and method for pre-validating data at a remote server prior to upgrading a syncing application. After initiating a remote server syncing application upgrade, syncing is suspended with the client device. An initial (pre-upgrade) server manifest is created of information derived from the mirrored copy of the client device stored data, and the mirrored copy of the client device stored data is archived. In response to a request, a client manifest is received, derived from data stored at the client device. The client manifest is compared to the initial server manifest, and if the client manifest matches the initial server manifest, the synching application upgrade is installed the remote server resyncs with the client device. Also disclosed is a method for pre-validating data at a client device prior to upgrading a syncing application.

### BACKGROUND OF THE INVENTION

### 1. Field of the Invention

This invention generally relates to software updating and, more particularly, to a system and method for validating the data of synched devices when the syncing applications are modified.

### 2. Description of the Related Art

The problem to be solved is validating the integrity of user data migrated from one version of an application to a newer version, when the software is upgraded and restarted. The upgrade can include one or both of a cloud service or device syncing application.

### Definitions

Data Migration: the moving of existing users data from one active system to a new upgraded system.

Data Validation: the comparison of users' data on original system and new upgraded system.

Types of Data Validated: File and Folder contents; File and Folder path names.

FIG. 12 is a block diagram of an exemplary cloud service environment (prior art). The client devices connect from within a local area network (IAN) to a wide area network (WAN), generally through a proxy/firewall server. The client devices and cloud services communicate using well-known network communication protocols, such as hypertext transfer protocol (HTTP). The client devices may provide:
1. A bi-directional syncing of folder/file storage structure between the client device (local) and cloud service.
2. Sharing a subset of folder/file storage structure between accounts, which may be on separate devices.

The syncing software operating on the cloud service and/or operating on the client devices is periodically upgraded. When the cloud based software is upgraded, the following steps generally occur:
1. The cloud service is put into maintenance mode.
2. Client device access to the cloud and syncing service is paused.
3. Client device syncing application goes into a suspended state.
4. The software is upgraded on the cloud service.
5. The cloud service is put into operational mode.
6. Client device access to the cloud and syncing service is resumed.

When the client device syncing software is upgraded, the following steps generally occur:
1. The cloud service continues to run in operational mode.
2. Client device syncing application goes into a suspended state.
3. The device syncing software on the client device is upgraded.
4. The client device syncing application goes into a resume state.

Conventionally, when the cloud service and/or device syncing application(s) are upgraded and restarted, the integrity validation of migrated user data in the cloud and device syncing applications is checked manually by:

1. Seeding one or more desktop (client) sync devices (personal computers (PCs)) with predetermined folder/file data mimicking a customer's data.

2. Building a manifest of the seeded content (folders/files).

3. Performing the cloud service and/or device syncing application(s) upgrade and restart.

4. Manually performing a visual comparison of user data in the original version of cloud service and device syncing applications to user data in the upgraded version of the cloud and device syncing applications.

5. Verifying there are no differences between the user data in original version of the cloud and device syncing applications and the upgraded version of the cloud service and device syncing applications (folders/files).

It would be advantageous if software upgrades to synced devices could be performed without manually verifying that the stored data has not been corrupted.

### SUMMARY OF THE INVENTION

Disclosed herein are a system and method for validating the integrity of migrated data that is performed automatically, without direct human intervention, when cloud service (remote) or client device syncing application software is upgraded and restarted. The process presumes there is existing user data in the cloud service and device syncing applications, whereby the user data on both the cloud service and device syncing application is a mirror (identical) to each other. Prior to performing the software upgrade, a backup is performed of existing user data in the current version of cloud service. A pre-upgrade manifest of existing user data in the current version of cloud service is created, capturing folder and file path and size checksums. The device syncing validation application creates its own pre-upgrade manifest, capturing folder and file path and size checksums. A comparison (pre-check) is performed of the cloud service and device syncing application pre-upgrade manifests, verifying the cloud service and device syncing application pre-upgrade folder and file path and size checksums match—before initiating the upgrade.

After the cloud service and/or device syncing application software upgrade(s) have been installed, the device syncing application creates a post-upgrade manifest capturing folder and file path and size checksums. If the device syncing application's post-upgrade checksums matches the pre-upgraded (initial) device syncing application checksums, the validation is complete. If the device syncing application's post-upgrade checksums do not match the pre-upgraded device syncing application checksums, the cloud service pre-upgrade manifest and device syncing application post-upgrade manifests are compared and any differences are noted. Invalid folder/files in the cloud and device syncing application(s) are removed. Missing, or correct folder/files from the pre-upgrade backup of the user cloud data are retrieved and added to the user's post-upgrade cloud service application. After resyncing with the cloud service, the device syncing application creates a new post upgrade manifest of the current user data capturing folder and file path and size checksums, to reverify the integrity of the migrated user data after a corrective action is taken. The cloud service pre-upgrade manifest and the new device syncing application post-upgrade manifests are again compared, verifying the device syncing application new post-upgrade checksums now match the cloud pre-upgrade checksums.

Thus, automated methods are used to verify that the user's data being synced stays correct after the sync managing software is upgraded. Automated methods are used to restore the user's data to its pre-upgraded state if it is not correct after the sync managing software is upgraded.

Accordingly, a method is provided for pre-validating data at a remote server (cloud service) prior to upgrading a syncing application. The method provides a remote server with a mirrored copy of client device stored data, a syncing application network-connected to a client device, and an uninstalled upgraded syncing application. After initiating a remote server syncing application upgrade, syncing is suspended with the client device. An initial (pre-upgrade) server manifest is created of information derived from the mirrored copy of the client device stored data, and the mirrored copy of the client device stored data is archived. In response to a request, a client manifest is received, derived from data stored at the client device. The client manifest is compared to the initial server manifest, and if the client manifest matches the initial server manifest, the synching application upgrade is installed the remote server resyncs with the client device.

If the client manifest does not match the initial server manifest, unmatched data is determined. The remote server resyncs with the client device, requests the unmatched data, and archives it before installing the syncing application update. An updated server manifest is created, compared to the initial server manifest, and if they match, the mirrored copy of the client device stored data is updated with the archived unmatched data.

Subsequent to installing the syncing application upgrade, a post-updated server manifest is created, and the mirrored copy of the client device stored data is archived. The remote server resyncs with the client device to receive a post-upgraded client manifest, which is compared to the post-updated server manifest. If the post-updated client manifest fails to match the post-updated server manifest, the unmatched data is determined, and the mirrored copy of the client device stored data is updated with the archived unmatched data.

Also disclosed is a method for pre-validating data at a client device prior to upgrading a syncing application. The method provides a client device with a local copy of client device stored data, a syncing application network-connected to a remote server with a mirrored copy of the client device stored data, and an uninstalled upgraded syncing application. After initiating a client device syncing application upgrade, syncing is suspended with the remote server. A backup/manifest request is sent to the remote server, which creates a server manifest of information derived from the mirrored copy of the client device stored data, including a server checksum. Likewise, the client device creates a client manifest including a client checksum, derived from the local copy of the client device stored data, and sends the client checksum to the remote server. The remote server archives the mirrored copy of the client device stored data, compares the client checksum to the server checksum, and if the client checksum matches the server checksum, the client device receives directions from the remote server to install the synching application upgrade and resync with the remote server.

Additional details of the above-described methods, as well as systems for validating data when upgrading a syncing application, are provided below.

### BRIEF DESCRIPTION OF THE DRAWINGS

FIG. 1 is a schematic block diagram of a system for pre-validating data at a remote server prior to upgrading a syncing application.

FIG. 2 is a schematic block diagram of a system for pre-validating data at a client device prior to upgrading a syncing application.

FIG. 3 is a diagram depicting a sequence of actions performed in updating cloud service syncing software.

FIG. 4 is a diagram depicting a continuation of the sequence of actions performed in FIG. 3.

FIG. 5 is a diagram depicting a sequence of actions performed after installation of the cloud service syncing software upgrade.

FIG. 6 is a diagram depicting a sequence of actions performed in upgrading client device syncing software.

FIG. 7 is a diagram depicting a continuation of the sequence of actions performed in FIG. 6.

FIG. 8 is a diagram depicting a continuation of the sequence of actions performed in FIG. 7.

FIG. 9 is a diagram depicting a continuation of the sequence of actions performed in FIG. 8.

FIGS. 10A and 10B are flowcharts illustrating a method for pre-validating data at a remote server prior to upgrading a syncing application.

FIGS. 11A and 11B are flowcharts illustrating a method for pre-validating data at a client device prior to upgrading a syncing application.

FIG. 12 is a block diagram of an exemplary cloud service environment (prior art).

### DETAILED DESCRIPTION

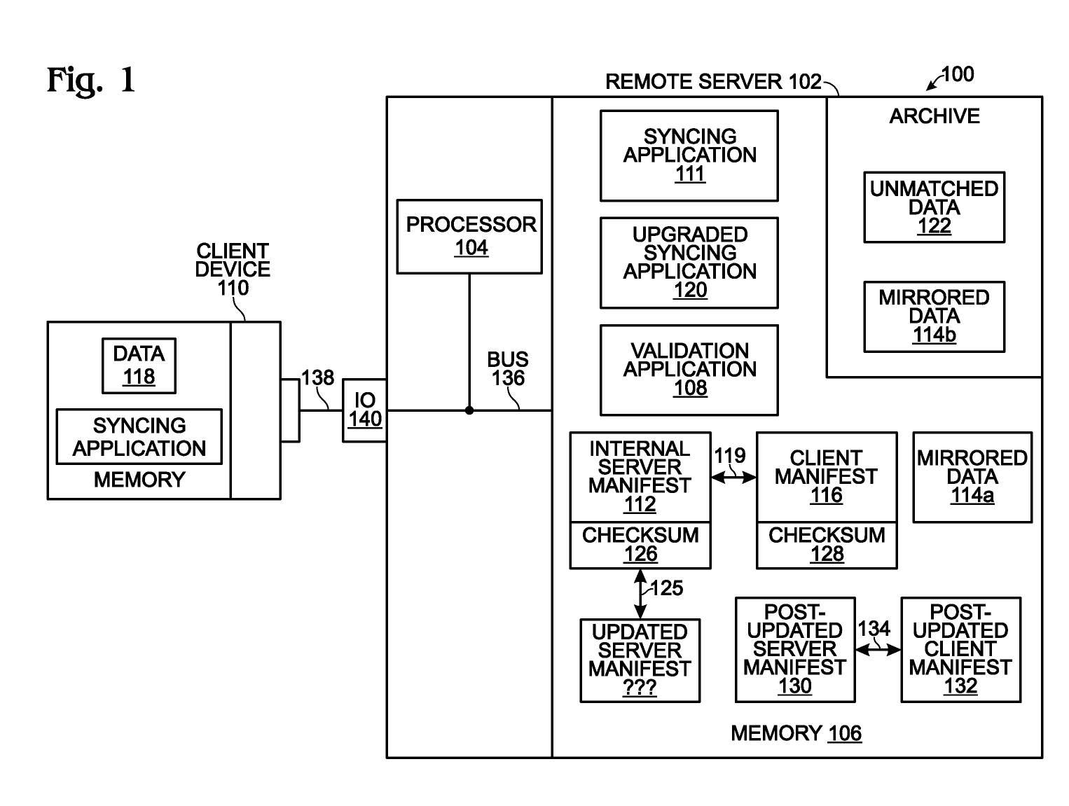

FIG. 1 is a schematic block diagram of a system for pre-validating data at a remote server prior to upgrading a syncing application. The system 100 comprises a remote server 102, such as a cloud service, with a processor 104, and a non-transitory memory 106. A validation application 108 is embedded in the non-transitory memory 106 and enabled as a sequence of processor executable instructions for pre-validating a mirrored copy of client device data stored in the non-transitory memory prior to upgrading a remote server syncing application. In response to the upgrade being initiated, the validation application 108 suspends syncing between the remote server 102 and a client device 110, as performed by initial syncing application 111. The term “syncing” is typically understood to be an abbreviation for the process of data synchronization, where multiple copies of a dataset are maintained in coherence with one another. The validation application 108 creates an initial server manifest 112 of information derived from the mirrored copy of the client device stored data 114a, and archives the mirrored copy of the client device stored data 114b in the non-transitory archive memory 106.

For simplicity, the archive memory is shown as a separate sector of memory 106, however, it should be understood that the archive memory may be a different physical medium than memory 106, and need not be co-located with memory 106. The validation application receives a client manifest 116 derived from data 118 stored at the client device 110, compares the client manifest to the initial server manifest 112, as represented by the line marked 119, and if the client manifest matches the initial server manifest, installs the synching application upgrade 120 and resyncs the remote server 102 with the client device. In one aspect, the validation application is a component of the initial or updated syncing application.

However, if the client manifest 116 fails to match the initial server manifest 112, the validation application 108 determines unmatched data, resyncs with the client device 110, and requests the unmatched data 122 from the client device. Unmatched data is typically a corrupted file, missing file, corrupted file name, wrong version of a file, or a corrupted file path. After archiving the unmatched (corrected) data in memory 106, the validation application installs the syncing application upgrade 120, creates an updated server manifest 124, and compares the initial server manifest 112 to the updated server manifest, as represented by line 125. If the updated server manifest 124 matches the initial server manifest 112, the validation application updates the mirrored copy of the client device stored data 114 with the unmatched data 122 archived in memory 106.

In one aspect, the validation application 108 creates the initial server manifest 112 with an initial server checksum 126, receives the client manifest 116 with a client checksum 128, and compares the client checksum to the initial server checksum. More explicitly, the initial server checksum 126 may comprise a checksum of stored data folder path names, a checksum of file path names, and a checksum of file contents. Likewise, the client checksum 128 may comprise a checksum of folder path names, a checksum of file path names, and a checksum of file contents.

In another aspect, the initial server manifest 112 comprises a list of account information such as client folders, files, file sizes, file paths, last change dates, and combinations thereof. Likewise, the client manifest 116 may comprise a list of account information selected from a group consisting of folders, files, file sizes, file paths, last change dates, and combinations thereof. The validation application 108 determines the unmatched data, when necessary, by comparing the initial server manifest account list to the client manifest account list.

In one aspect, subsequent to installing the syncing application upgrade 120, the validation application 108 creates a post-updated server manifest 130 of information derived from the mirrored copy of the client device stored data 114, archives the mirrored copy of the client device stored data in memory 106, and resyncs the remote server 102 with the client device 110. The validation application 108 receives a post-upgraded client manifest 132 derived from data 118 stored at the client device 110, and compares the post-updated client manifest 132 to the post-updated server manifest 130, as represented by line 134. The validation application 108 determines unmatched data if the post-updated client manifest 132 fails to match the post-updated server manifest 130, and updates the mirrored copy of the client device stored data 114 with the archived unmatched data in memory 106. The post-updated client manifest 132 and post-updated server manifest 130 may include the same checksums and list of account information as described above for the initial server manifest 112 and client manifest 116.

The remote server 102 typically employs a bus 136 or other communication mechanism for communicating information, with the processor 104 coupled to the bus for processing information. The remote server memory 106 may include a main memory, such as a random access memory (RAM) or other dynamic storage device, coupled to the bus for storing information and instructions to be executed by processor. These memories may also be referred to as a computer-readable medium. The execution of the sequences of instructions contained in a computer-readable medium 106 may cause processor 104 to perform steps associated with validating data. The practical implementation of such a computer system would be well known to one with skill in the art. A computer-readable medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

The remote server 102 may communicate with the client device 110 via a network connection 138, such as the Internet, Ethernet, Bluetooth, cellular, WiFi, phone line, or an intranet. The interface to the network connection 138 may be an input/output (IO) interface 140, which may take the form of a modem, an Ethernet card, or any other appropriate data communications device such as USB. The physical communication link 138 may be optical, wired, or wireless.

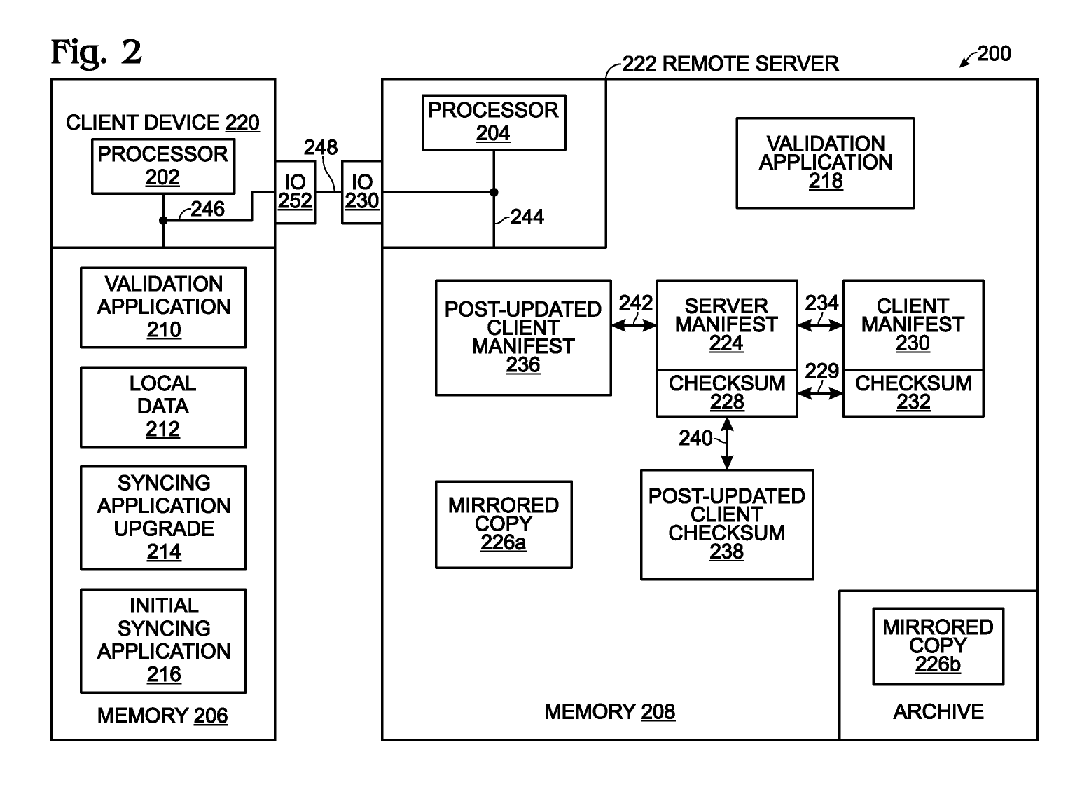

FIG. 2 is a schematic block diagram of a system for pre-validating data at a client device prior to upgrading a syncing application. The system 200 comprises a client device processor 202, a remote server processor 204, a client device non-transitory memory 206, and a remote server non-transitory memory 208. A client-side validation application 210 is embedded in the client device non-transitory memory 206 and enabled as a sequence of client device processor executable instructions for pre-validating a local copy 212 of client device data stored in the client device non-transitory memory, prior to installing a client device syncing application upgrade 214, to replace initial syncing application 216.

A server-side validation application 218 is embedded in the remote server non-transitory memory 208 and enabled as a sequence of remote server processor executable instructions. In response to a client device syncing application upgrade being initiated, the client-side validation application 210 suspends syncing between the client device 220 and the remote server 222, and sends a backup/manifest request to the remote server. The server-side validation application 218 creates a server manifest 224 of information derived from the mirrored copy of the client device stored data 226a, including a server checksum 228. The client-side validation application 210 creates a client manifest 230 including a client checksum 232, derived from the local copy 212 of the client device stored data, and sends the client checksum 232 to the remote server 222.

The server-side validation application 218 archives the mirrored copy of the client device stored data 226b in memory 208, compares the client checksum 232 to the server checksum 228, as represented by line 229. If the client checksum 232 matches the server checksum 228, the server-side application 218 sends instructions to the client-side validation application 210 to install the synching application upgrade 214 and resync the client device 220 with the remote server 222.

The server-side validation application 218 requests the client manifest 230 when the client checksum 232 fails to match the server checksum 228. The client manifest 230 includes information such as data folder path names, a checksum of file path names, a checksum of file contents, client folders, files, file sizes, file paths, last change dates, and combinations thereof. The server-side validation application 218 compares the client manifest 230 to the server manifest 224, which also includes information such as data folder path names, a checksum of file path names, a checksum of file contents, client folders, files, file sizes, file paths, last change dates, and combinations thereof. The comparison is represented by line 234. In response to comparing the client manifest 230 to the server manifest 224, the server-side validation application 218 determines unmatched data and sends data discrepancy information to the client-side validation application device 210. The client-side validation application 210 fixes discrepancies in the local copy 212 of the client stored data in the client device memory 206.

Subsequent to installing the syncing application upgrade 214, the client-side validation application 210 creates a post-updated client manifest 236 of information such as data folder path names, a checksum of file path names, a checksum of file contents, client folders, files, file sizes, file paths, last change dates, and combinations thereof, and sends a post-updated checksum 238 to the remote server 222. The server-side validation application 218 compares the post-updated client checksum 238 to the server checksum 228, as represented by line 240. The server-side validation application 218 requests the post-updated client manifest 236 if the post-updated client checksum 238 fails to match the server checksum 228, and compares the post-updated client manifest to the server manifest 224, as represented by line 242. The server manifest 224 includes information such as data folder path names, a checksum of file path names, a checksum of file contents, client folders, files, file sizes, file paths, last change dates, and combinations thereof.

The server-side validation application 218 determines unmatched data in response to comparing the post-updated client checksum 238 with the server checksum 228, and updates the mirrored copy of the client device stored data 226a with the archived unmatched data in memory 208.

As in the system of FIG. 1, the remote server 222 and client device 220 may respectively employs buses 244 and 246 to enable communications between their respective applications, processors, and IO ports. The remote server 222 may communicate with the client device 210 via a network connection 248, such as the Internet, WiFi, Ethernet, Bluetooth, cellular, phone line, or an intranet. The device IOs 250 and 252 may take the form of a modem, an Ethernet card, or any other appropriate data communications device such as USB. The physical communication link 248 may be optical, wired, or wireless.

One exemplary environment for the systems of FIGS. 1 and 2 is a computer data storage (cloud) service hosted on a readily accessible external wide area network (WAN), as shown in FIG. 12. The cloud service provides an application programming interface (API) accessible via a network connection. The service may provide the following services to client devices such as personal computers (PCs):
1. User Accounts
2. Bi-Directional Transfer of File/Data
3. File/Data Sharing
4. Sync (Mirror) on client desktop devices.

FIG. 3 is a diagram depicting a sequence of actions performed in updating cloud service syncing software. When the cloud service (remote server) is to be upgraded, prior to the software upgrade, the cloud service is put into maintenance mode. The maintenance mode suspends updates between the users' cloud service and client syncing devices during the period of maintenance mode. During maintenance mode, the following additional actions occur:
1. Although not explicitly shown, the client device is instructed to suspend syncing and to cease making any changes to client side stored data. On the cloud service side, a manifest is created of the contents of the users account. The manifest may consists of
   a. A list of all folders/files in the account, along with file size, file path and last change date.
   b. A checksum of folder/file path names, and a checksum of file contents.
2. The contents of the user's account is backed up.
   a. The contents are put into a compressed archive.
   b. The compressed archive is stored on commodity storage devices.
3. On the desktop client sync side, the cloud service sends a request for the client side to create a manifest. The manifest may consist of:
   a. A list of all folders/files in account, along with file size, file path and last change date.
   b. A checksum of folder/file pathnames, and a checksum of file contents
4. The client device sends its checksum portion of the manifest to the cloud service.
5. The cloud service verifies the integrity of user's system by comparing the cloud service side to the client side's checksums.
   a. If they do not match, the cloud service requests the corresponding client side syncing device to resync.
   b. If there are any conflicts remaining, the cloud service requests the client side to send any unmatched content (in conflict) to the cloud service. The cloud service then stores the unmatched content (in conflict) in the user's backup archive.

Once the above steps have been completed on all accounts, the upgrade of the cloud service is initiated. Upon completion of the service upgrade, the cloud service repeats the step of creating a manifest, now post-upgrade, per user account. A comparison is made between the pre- and post-upgrade checksum portions of the manifests of each user account.

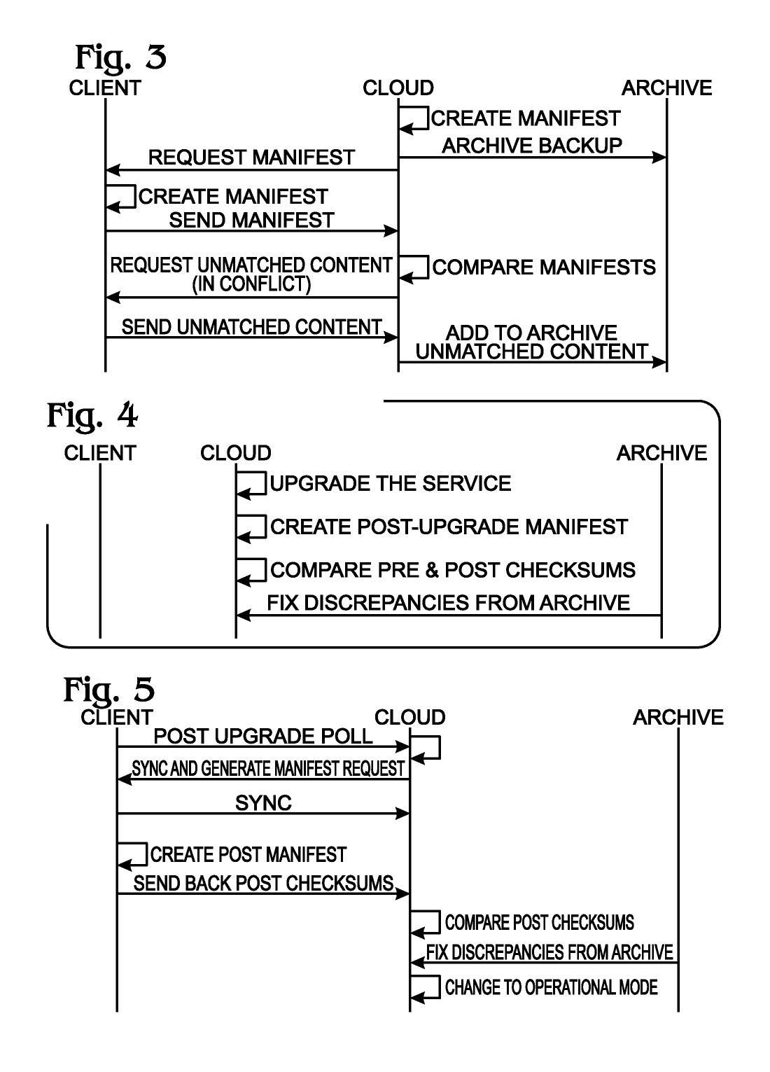

FIG. 4 is a diagram depicting a continuation of the sequence of actions performed in FIG. 3. If there are any discrepancies, the system requires either automatic or manual intervention by those performing the upgrade to the service. This intervention may result in either corrective actions taken to correct user's accounts, such as replacing the user's current content with the content backed up in the archive, or a roll back of the service upgrade.

FIG. 5 is a diagram depicting a sequence of actions performed after installation of the cloud service syncing software upgrade. If the pre- and post-upgrades checks pass, and/or discrepancies are reconciled, the cloud service waits for the next poll request from each desktop client syncing device, and responds back to the desktop client syncing device to do an initial first post-upgrade sync and generate a manifest.

The desktop client syncing device re-syncs with the cloud service. Upon completion of the sync, the desktop client syncing device suspends any further syncing. The device then generates a post-upgrade manifest. The checksums portion of the manifest is sent back to the cloud service. The cloud service performs a checksum comparison between the cloud service's version of the post-upgrade checksums and the desktop client syncing device version of the post-upgrade checksums.

If there are any discrepancies, the system requires either automatic or manual intervention by those performing the upgrade to the service. This intervention may result in either corrective actions taken to correct user's accounts, such as replacing the user's current content with the content backed up in the archive, or a roll back of the cloud service upgrade. Upon completion of the upgrade and manifest checks, and corrective actions (if any), the cloud service is taken out of maintenance mode and returns to operational mode.

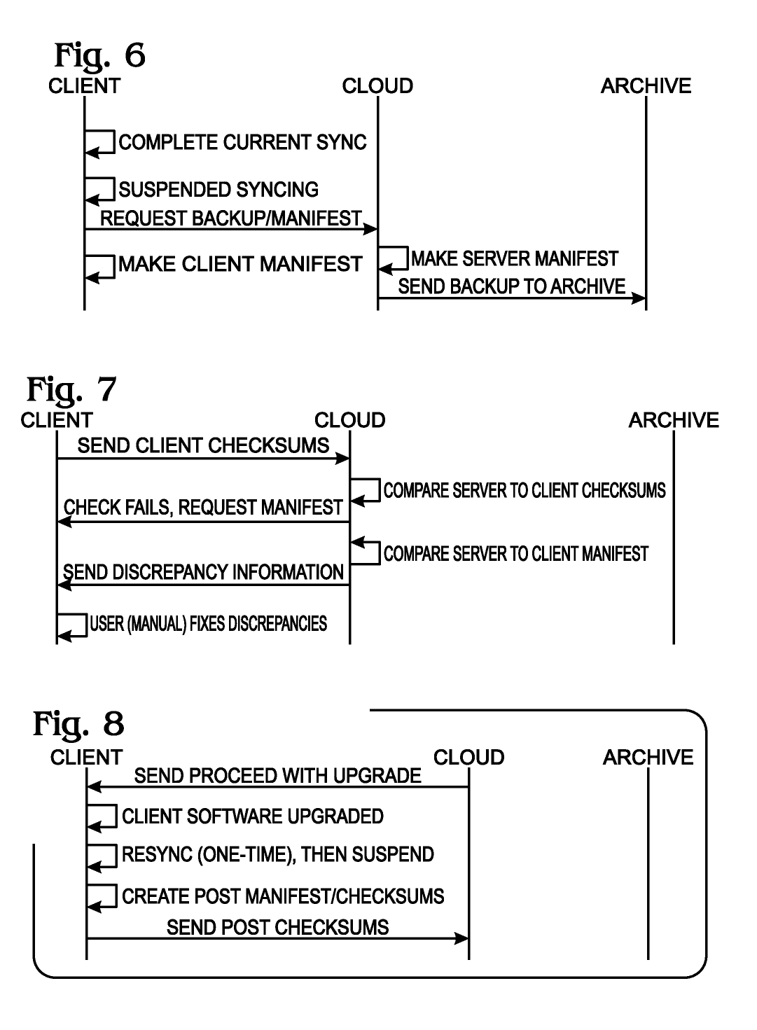

FIG. 6 is a diagram depicting a sequence of actions performed in upgrading client device syncing software. When the software of one or more desktop sync clients is to be updated, prior to the software upgrade, the desktop sync client may perform the following:
Completing any ongoing syncing.
Suspending any additional syncing activity and changes to client side data.
Making a request to the cloud service to backup the cloud version of the account to archive and make a manifest (as described above).

In parallel, the desktop sync client makes its own manifest (as described above).

FIG. 7 is a diagram depicting a continuation of the sequence of actions performed in FIG. 6. Once the desktop client syncing device completes its manifest, it sends the folder/file checksums to the cloud service. The cloud service then compares its (server) checksums with the checksums received from the desktop client syncing device (pre-check). If the checksums do not match, the cloud service requests the file/folder manifest from the desktop syncing client device. The server and client manifests are then compared to identify the discrepancies. The discrepancy information is then sent back to the desktop syncing client device for manual resolution by the operator of the desktop syncing client device. The operator may manually make corrections, or manually select the option to automatically have the client device accept updates from the remote server's archive of the client data such that the client side matches the server's archive.

FIG. 8 is a diagram depicting a continuation of the sequence of actions performed in FIG. 7. Otherwise (pre-check passes), the cloud service sends a message to the desktop client syncing device to proceed with the upgrade. Upon receiving the message, the desktop client syncing device performs the upgrade of the client side of the software.

Upon completion of the upgrade, the desktop client syncing device performs an initial resync with the cloud service. Once the resync has completed, and while still in a suspended state, the desktop client syncing device creates a new manifest/checksums (post-upgrade). The desktop client syncing device then sends its checksums to the cloud service.

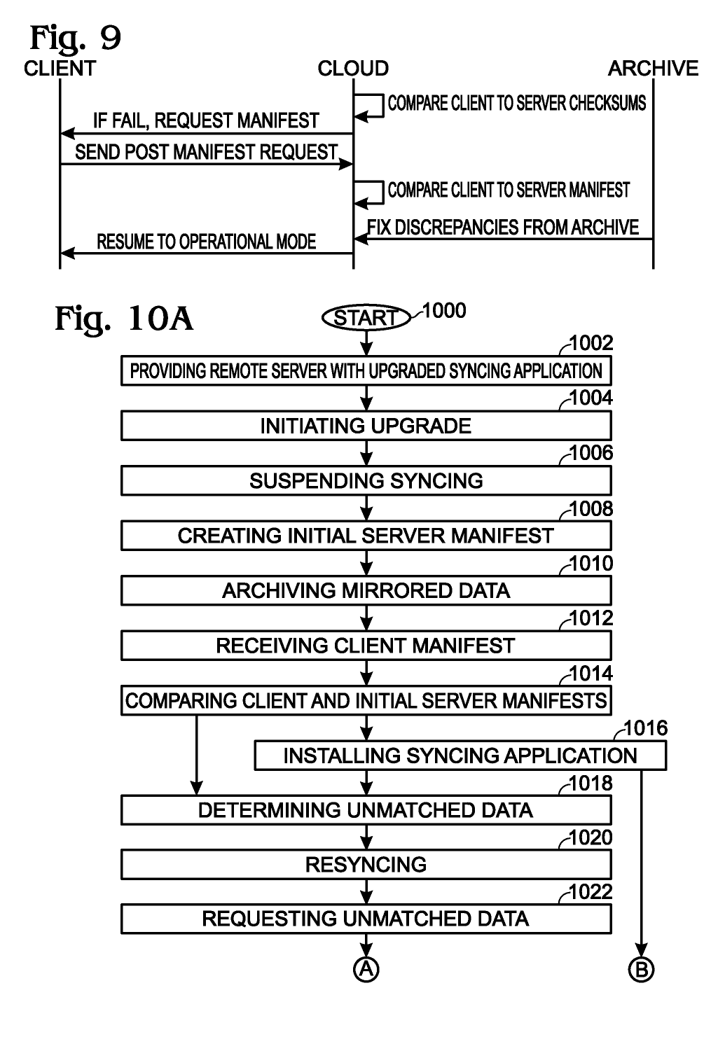

FIG. 9 is a diagram depicting a continuation of the sequence of actions performed in FIG. 8. The cloud service then compares its (server) checksums with the checksums received from the desktop client syncing device (post-upgrade). If the checksums do not match, the cloud service sends a request to the desktop client syncing device to send its folder/file manifest to the cloud service.

If there are any discrepancies, the client side upgrade requires either automatic or manual intervention. This intervention may result in either corrective actions taken to correct user's account, such as replacing the user's current content with the content backed up in the archive, or a roll back of the client upgrade. If the post-upgrade checksums pass or the discrepancies are resolved, the cloud service then sends a message to the desktop client syncing device to resume syncing (operational state).

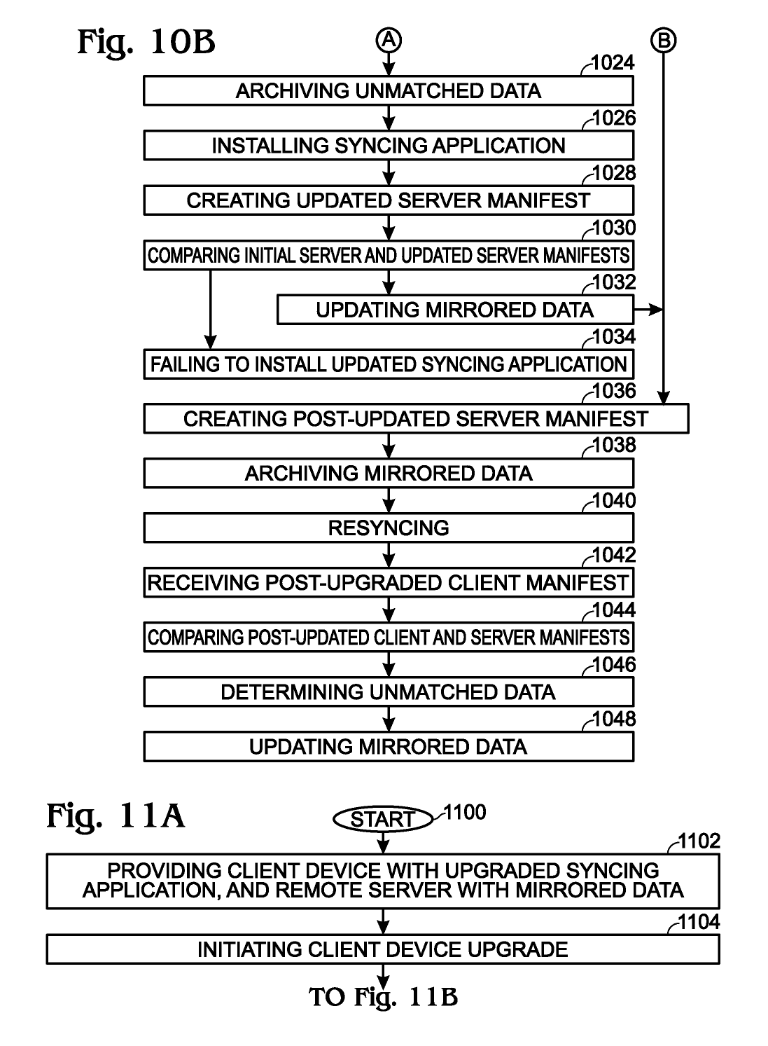

FIGS. 10A and 10B are flowcharts illustrating a method for pre-validating data at a remote server prior to upgrading a syncing application. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 1000.

Step 1002 provides a remote server with a mirrored copy of client device stored data, a syncing application network-connected to a client device, and an uninstalled upgraded syncing application. Step 1004 initiates a remote server syncing application upgrade. Step 1006 suspends syncing with the client device. Step 1008 creates an initial server manifest of information derived from the mirrored copy of the client device stored data. Step 1010 archives the mirrored copy of the client device stored data. In response to a request to the client device, Step 1012 receives a client manifest derived from data stored at the client device. Step 1014 compares the client manifest to the initial server manifest. If the client manifest matches the initial server manifest, Step 1016 installs the synching application upgrade and resyncs with the client device.

If the client manifest fails to match the initial server manifest, Step 1018 determines unmatched data and Step 1020 resyncs with the client device. Step 1022 requests the unmatched data from the client device. Step 1024 archives the unmatched data and Step 1026 installs the syncing application update. Step 1028 creates an updated server manifest. Step 1030 compares the initial server manifest to the updated server manifest. If the updated server manifest matches the initial server manifest, Step 1032 updates the mirrored copy of the client device stored data with the archived unmatched data. If the client manifest fails to match the initial server manifest, Step 1034 fails to install the syncing application upgrade.

In one aspect, creating the initial server manifest of information derived from the mirrored copy of the client device stored data in Step 1008 includes creating an initial server checksum, and wherein receiving the client manifest of derived from data stored at the client device in Step 1012 includes receiving a client checksum. Then, comparing the client manifest to the initial server manifest in Step 1014 includes comparing the client checksum to the initial server checksum. The initial server checksum may include a checksum of stored data folder path names, a checksum of file path names, or a checksum of file contents. Likewise, the client checksum may include a checksum of folder path names, a checksum of file path names, or a checksum of file contents.

In another aspect, creating the initial server manifest of information derived from client device stored data in Step 1008 includes creating a list of account information such as client folders, files, file sizes, file paths, last change dates, and combinations thereof. Likewise, receiving the client manifest of derived from data stored at the client device in Step 1012 includes receiving a list of account information such as folders, files, file sizes, file paths, last change dates, and combinations thereof. Then, determining the unmatched data in Step 1018 includes comparing the initial server manifest account list to the client manifest account list.

Subsequent to installing the syncing application upgrade in Step 1016, Step 1036 creates a post-updated server manifest of information derived from the mirrored copy of the client device stored data. Step 1038 archives the mirrored copy of the client device stored data and Step 1040 resyncs with the client device. Step 1042 receives a post-upgraded client manifest derived from data stored at the client device. Step 1044 compares the post-updated client manifest to the post-updated server manifest. If the post-updated client manifest fails to match the post-updated server manifest, Step 1046 determines unmatched data and Step 1048 updates the mirrored copy of the client device stored data with the archived unmatched data.

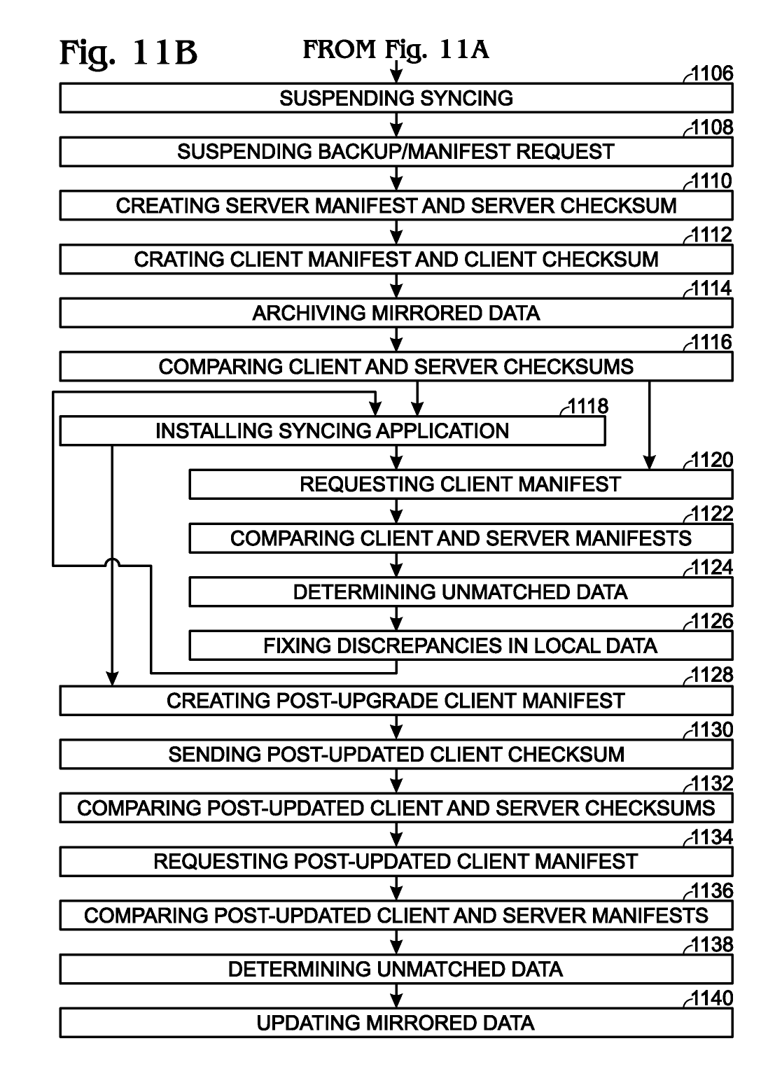

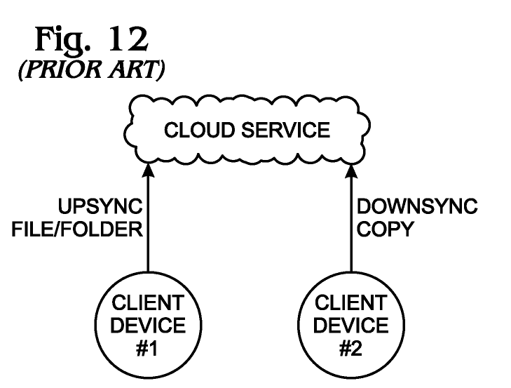

FIGS. 11A and 11B are flowcharts illustrating a method for pre-validating data at a client device prior to upgrading a syncing application. The method begins at Step 1100. Step 1102 provides a client device with a local copy of client device stored data, a syncing application network-connected to a remote server with a mirrored copy of the client device stored data, and an uninstalled upgraded syncing application. Step 1104 initiates a client device syncing application upgrade. Step 1106 suspends syncing with the remote server. Step 1108 sends a backup/manifest request to the remote server. In Step 1110 the remote server creates a server manifest of information derived from the mirrored copy of the client device stored data, including a server checksum. In Step 1112 the client device creates a client manifest including a client checksum, derived from the local copy of the client device stored data, and sends the client checksum to the remote server. In Step 1114 the remote server archives the mirrored copy of the client device stored data. In Step 1116 the remote server compares the client checksum to the server checksum, and if the client checksum matches the server checksum, in Step 1118 the client device receives directions from the remote server to install the synching application upgrade and resync with the remote server.

If the client checksum fails to match the server checksum, in Step 1120 the remote server requests the client manifest. The client manifest includes information such as data folder path names, a checksum of file path names, a checksum of file contents, client folders, files, file sizes, file paths, last change dates, and combinations thereof. In Step 1122 the remote server compares the client manifest to a server manifest including information such as data folder path names, a checksum of file path names, a checksum of file contents, client folders, files, file sizes, file paths, last change dates, and combinations thereof. In response to comparing the client manifest to the server manifest, in Step 1124 the remote server determines unmatched data and sends data discrepancy information to the client device. Step 1126 fixes discrepancies in the local copy of the client stored data.

Subsequent to installing the syncing application upgrade at the client device, Step 1128 creates a post-updated client manifest of information such as data folder path names, a checksum of file path names, a checksum of file contents, client folders, files, file sizes, file paths, last change dates, and combinations thereof. In Step 1130 the client device sends a post-updated checksum to the remote server. In Step 1132 the remote server compares the post-updated client checksum to the server checksum. If the post-updated client checksum fails to match the server checksum, in Step 1134 the remote server requests the post-updated client manifest. In Step 1136 the remote server compares the post-updated client manifest to a server manifest including information such as data folder path names, a checksum of file path names, a checksum of file contents, client folders, files, file sizes, file paths, last change dates, and combinations thereof. In Step 1138 the remote server determines unmatched data, and Step 1140 updates the mirrored copy of the client device stored data with the archived unmatched data.

A system and method have been provided for validating data in a network of synced devices before and after a syncing application upgrade. Examples of particular message structures, processes, and hardware units have been presented to illustrate the invention. However, the invention is not limited to merely these examples. Although the invention has been described in the context of syncing application upgrades, it should also be understood that the invention is applicable to other types of software upgrades and modifications. Other variations and embodiments of the invention will occur to those skilled in the art.

We claim:

1. A method for pre-validating data at a remote server prior to upgrading a syncing application, the method comprising:
providing a remote server with a mirrored copy of client device stored data, a syncing application network-connected to a client device, and an uninstalled upgraded syncing application;
initiating a remote server syncing application upgrade;
suspending syncing with the client device;
creating an initial server manifest of information derived from the mirrored copy of the client device stored data;
archiving the mirrored copy of the client device stored data;
in response to a request to the client device, receiving a client manifest derived from data stored at the client device;
comparing the client manifest to the initial server manifest; and,
when the client manifest matches the initial server manifest, installing the synching application upgrade and resyncing with the client device.

2. The method of claim 1 further comprising:
when the client manifest fails to match the initial server manifest, determining unmatched data;
resyncing with the client device;
requesting the unmatched data from the client device;
archiving the unmatched data;
installing the syncing application update;
creating an updated server manifest;
comparing the initial server manifest to the updated server manifest; and,
when the updated server manifest matches the initial server manifest, updating the mirrored copy of the client device stored data with the archived unmatched data.

3. The method of claim 1 wherein creating the initial server manifest of information derived from the mirrored copy of the client device stored data includes creating an initial server checksum;
wherein receiving the client manifest of derived from data stored at the client device includes receiving a client checksum; and,
wherein comparing the client manifest to the initial server manifest includes comparing the client checksum to the initial server checksum.

4. The method of claim 3 wherein creating the initial server checksum includes creating an initial server checksum of stored data folder path names, a checksum of file path names, and a checksum of file contents; and,
wherein receiving the client checksum includes receiving a client checksum of folder path names, a checksum of file path names, and a checksum of file contents.

5. The method of claim 4 wherein creating the initial server manifest of information derived from client device stored data includes creating a list of account information selected from a group consisting of client folders, files, file sizes, file paths, last change dates, and combinations thereof;
wherein receiving the client manifest of derived from data stored at the client device includes receiving a list of account information selected from a group consisting of folders, files, file sizes, file paths, last change dates, and combinations thereof, and,
wherein determining the unmatched data includes comparing the initial server manifest account list to the client manifest account list.

6. The method of claim 1 further comprising:
when the client manifest fails to match the initial server manifest, failing to install the syncing application upgrade.

7. The method of claim 1 further comprising:
subsequent to installing the syncing application upgrade, creating a post-updated server manifest of information derived from the mirrored copy of the client device stored data;
archiving the mirrored copy of the client device stored data;
resyncing with the client device;
receiving a post-upgraded client manifest derived from data stored at the client device;
comparing the post-updated client manifest to the post-updated server manifest;
when the post-updated client manifest fails to match the post-updated server manifest, determining unmatched data; and,
updating the mirrored copy of the client device stored data with the archived unmatched data.

8. A method for post-validating data at a remote server after upgrading a syncing application, the method comprising:
providing a remote server with a mirrored copy of client device stored data, and an upgraded syncing application network-connected to a client device;
subsequent to updating the syncing application, creating a post-updated server manifest of information derived from the mirrored copy of the client device stored data;
archiving the mirrored copy of the client device stored data;
resyncing with the client device;
receiving a post-updated client manifest derived from data stored at the client device;
comparing the post-updated client manifest to the post-updated server manifest;
when the post-updated client manifest fails to match the post-updated server manifest, determining unmatched data; and,
updating the mirrored copy of the client device stored data with the archived unmatched data.

9. A method for pre-validating data at a client device prior to upgrading a syncing application, the method comprising:
providing a client device with a local copy of client device stored data, a syncing application network-connected to a remote server with a mirrored copy of the client device stored data, and an uninstalled upgraded syncing application;
initiating a client device syncing application upgrade;
suspending syncing with the remote server;
sending a backup/manifest request to the remote server;
the remote server creating a server manifest of information derived from the mirrored copy of the client device stored data, including a server checksum;
the client device creating a client manifest including a client checksum, derived from the local copy of the client device stored data, and sending the client checksum to the remote server;
the remote server archiving the mirrored copy of the client device stored data;
the remote server comparing the client checksum to the server checksum; and,
when the client checksum matches the server checksum, the client device receiving directions from the remote server to install the synching application upgrade and resync with the remote server.

10. The method of claim 9 further comprising:
when the client checksum fails to match the server checksum, the remote server requesting the client manifest, where the client manifest includes information selected from a group consisting of data folder path names, a checksum of file path names, a checksum of file contents, client folders, files, file sizes, file paths, last change dates, and combinations thereof;
the remote server comparing the client manifest to a server manifest including information selected from a group consisting of data folder path names, a checksum of file path names, a checksum of file contents, client folders, files, file sizes, file paths, last change dates, and combinations thereof;
in response to comparing the client manifest to the server manifest, the remote server determining unmatched data and sending data discrepancy information to the client device; and,
fixing discrepancies in the local copy of the client stored data.

11. The method of claim 9 further comprising:
subsequent to installing the syncing application upgrade at the client device, creating a post-updated client manifest of information selected from a group consisting of data folder path names, a checksum of file path names, a checksum of file contents, client folders, files, file sizes, file paths, last change dates, and combinations thereof:
the client device sending a post-updated checksum to the remote server;
the remote server comparing the post-updated client checksum to the server checksum;
when the post-updated client checksum fails to match the server checksum, the remote server requesting the post-updated client manifest;
the remote server comparing the post-updated client manifest to a server manifest including information selected from a group consisting of data folder path names, a checksum of file path names, a checksum of file contents, client folders, files, file sizes, file paths, last change dates, and combinations thereof,
the remote server determining unmatched data; and,
updating the mirrored copy of the client device stored data with the archived unmatched data.

12. A system for pre-validating data at a remote server prior to upgrading a syncing application, the system comprising:
a remote server;
a processor;
a non-transitory memory;
a validation application embedded in the non-transitory memory and enabled as a sequence of processor executable instructions for pre-validating a mirrored copy of client device data stored in the non-transitory memory prior to upgrading a remote server syncing application;
wherein the validation application, in response the upgrade being initiated, suspends syncing between the remote server and client device, creates an initial server manifest of information derived from the mirrored copy of the client device stored data, archives the mirrored copy of the client device stored data in the non-transitory archive memory, receives a client manifest derived from data stored at the client device, compares the client manifest to the initial server manifest, and when the client manifest matches the initial server manifest, installs the synching application upgrade and resyncs the remote server with the client device.

13. The system of claim 12 wherein the validation application determines unmatched data when the client manifest fails to match the initial server manifest, resyncs with the client device, requests the unmatched data from the client device, archives the unmatched data, installs the syncing application upgrade, creates an updated server manifest, compares the initial server manifest to the updated server manifest, and when the updated server manifest matches the initial server manifest, updates the mirrored copy of the client device stored data with the unmatched data archived in memory.

14. The system of claim 12 wherein the validation application creates the initial server manifest with an initial server checksum, receives the client manifest with a client checksum, and compares the client checksum to the initial server checksum.

15. The system of claim 14 wherein the validation application creates the initial server checksum comprising a checksum of stored data folder path names, a checksum of file path names, and a checksum of file contents, and receives the client checksum comprising a checksum of folder path names, a checksum of file path names, and a checksum of file contents.

16. The system of claim 15 wherein the validation application creates the initial server manifest comprising a list of account information selected from a group consisting of client folders, files, file sizes, file paths, last change dates, and combinations thereof, and receives the client manifest comprising a list of account information selected from a group consisting of folders, files, file sizes, file paths, last change dates, and combinations thereof, and,
wherein the validation application determines the unmatched data by comparing the initial server manifest account list to the client manifest account list.

17. The system of claim 12 wherein the validation application, subsequent to installing the syncing application upgrade, creates a post-updated server manifest of information derived from the mirrored copy of the client device stored data, archives the mirrored copy of the client device stored data in memory, resyncs the remote server with the client device, receives a post-upgraded client manifest derived from data stored at the client device, compares the post-updated client manifest to the post-updated server manifest; and,
wherein the validation application determines unmatched data when the post-updated client manifest fails to match the post-updated server manifest, and updates the mirrored copy of the client device stored data with the archived unmatched data in memory.

18. A system for pre-validating data at a client device prior to upgrading a syncing application, the system comprising:
a client device processor;
a remote server processor;
a client device non-transitory memory;
a remote server non-transitory memory;
a client-side validation application embedded in the client device non-transitory memory and enabled as a sequence of client device processor executable instructions for pre-validating a local copy of client device data stored in the client device non-transitory memory prior to installing a client device syncing application upgrade;
a server-side validation application embedded in the remote server non-transitory memory and enabled as a sequence of remote server processor executable instructions;
wherein the client-side validation application, in response to a client device syncing application upgrade being initiated, suspends syncing between the client device and the remote server, and sends a backup/manifest request to the remote server;
wherein the server-side validation application creates a server manifest of information derived from the mirrored copy of the client device stored data, including a server checksum;
wherein the client-side validation application creates a client manifest including a client checksum, derived from the local copy of the client device stored data, and sends the client checksum to the remote server; and,
wherein the server-side validation application archives the mirrored copy of the client device stored data in memory, compares the client checksum to the server checksum, and when the client checksum matches the server checksum, sends instructions to the client-side validation application to install the synching application upgrade and resync the client device with the remote server.

19. The system of claim 18 wherein the server-side validation application requests the client manifest when the client checksum fails to match the server checksum, where the client manifest includes information selected from a group consisting of data folder path names, a checksum of file path names, a checksum of file contents, client folders, files, file sizes, file paths, last change dates, and combinations thereof,
wherein the server-side validation application compares the client manifest to a server manifest including information selected from a group consisting of data folder path names, a checksum of file path names, a checksum of file contents, client folders, files, file sizes, file paths, last change dates, and combinations thereof;
wherein the server-side validation application, in response to comparing the client manifest to the server manifest, determines unmatched data and sends data discrepancy information to the client-side validation application device; and,
wherein the client-side validation application fixes discrepancies in the local copy of the client stored data in the client device memory.

20. The system of claim 18 wherein the client-side validation application, subsequent to installing the syncing application upgrade, creates a post-updated client manifest of information selected from a group consisting of data folder path names, a checksum of file path names, a checksum of file contents, client folders, files, file sizes, file paths, last change dates, and combinations thereof, and sends a post-updated checksum to the remote server;
wherein the server-side validation application compares the post-updated client checksum to the server checksum, requests the post-updated client manifest when the post-updated client checksum fails to match the server checksum, compares the post-updated client manifest to a server manifest including information selected from a group consisting of data folder path names, a checksum of file path names, a checksum of file contents, client folders, files, file sizes, file paths, last change dates, and combinations thereof; and,
wherein the server-side validation application determines unmatched data in response to comparing the post-updated client checksum with the server checksum, and updates the mirrored copy of the client device stored data with the archived unmatched data in memory.
